(19) United States
(12) Patent Application Publication
(10) Pub. No.: US 2014/0014886 A1
(43) Pub. Date: Jan. 16, 2014

(54) LIFT TABLE CONTROL

(71) Applicant: Rofa Industrial Automation AG, Kolbermoor (DE)

(72) Inventor: Manfred RUTH sen., Straubing (DE)

(73) Assignee: Rofa Industrial Automation AG, Kolbermoor (DE)

(21) Appl. No.: 13/901,264

(22) Filed: May 23, 2013

(30) Foreign Application Priority Data
Jul. 13, 2012 (DE) 20 2012 102 606.6
Jan. 24, 2013 (DE) 20 2013 100 340.9

(51) Int. Cl. B66F 7/06

(52) U.S. Cl. CPC B66F 7/065
USPC 254/122

(57) ABSTRACT

According to the invention, a scissor lift table is hereby proposed having a base unit and a carrier unit adjustable relative to the base unit by means of a scissor unit provided with a drive unit. A safety device of the scissor lift table comprises a monitoring element, which registers parameters of a motor, and a safety element, which processes safety-related signals. The safety device additionally comprises a drive control and a drive brake, wherein the drive control acts on the drive brake in the event of a disruption.

The present invention relates to a scissor lift table with the features of the subject matter of claim 1.

A scissor lift table of this kind is known, for example, from the publication EP 1 454 873 B1 and comprises a base unit, which can be provided for example with rollers or the like, and a carrier unit, which can be considered in the broadest sense to be a height-adjustable table top and which is adjustable plane-parallel relative to the base unit by means of a scissor unit provided with a drive unit. The scissor unit comprises on both sides relative to a table length central plane a pair of scissor members with two scissor members, respectively, which are connected to each other by a joint and one of which is mounted with one end on a first pivot bearing, which is arranged stationary on the base unit, and with the other end it is movably guided on the carrier unit. The other scissor member is mounted with one end on a second pivot bearing, which is arranged stationary on the carrier unit, and with the other end it is movably guided on the base unit. For actuating the pairs of scissor members, that is for lifting and lowering the carrier unit relative to the base unit, their drive unit has an elaborate lever structure which is engaged by a tensile means in the form of a cable, chain or belt.

A scissor lift table of this sort is also known, for example, from publication DE 10 2010 052 615 A1 and comprises a base unit, a hydraulic cylinder, which can be understood to be a safety device, and a carrier unit, which is formed as an upper frame forming a table and which is mounted height-adjustable by means of a scissor unit, wherein the scissor unit can be moved by a drive. The scissor unit comprises on both sides in relation to a vertical table length central plane one scissor member pair, respectively, with two scissor members which are connected to each other by a joint and one of which is mounted with one end on a first pivot bearing arranged stationary on the base unit, and with the other end it is movably guided on the carrier unit. The other scissor member is mounted with one end on a second pivot bearing arranged stationary on the carrier unit, and with its other end it is movably guided on the base unit. For moving the scissor members and lifting or lowering the carrier unit, a tensile element is arranged on one side on the scissor members and on the other side on the drive so that a winding and unwinding of the tensile element causes a vertical motion of the carrier unit. The previously known scissor lift tables comprise as a safety device a hydraulic cylinder, which is supposed to prevent a dropping of the carrier unit in the case of an operational disruption in that the cylinder maintains a current position of the carrier unit by means of the scissor members either via a direct operative connection or an indirect operative connection. This construction has several decisive disadvantages.

Since the hydraulic cylinders have to be ready for operation at any time and thus in any position of the carrier unit, they follow the motion of the carrier unit in every motion process. It is a common characteristic of all hydraulic cylinders that in order to function perfectly, they require a number of lubricating and hydraulic substances. Due to the continuous following of motions and the accompanying high actuation frequency, hydraulic cylinders use up lubricating and hydraulic substances over the span of their operating life, which makes them high-maintenance and costly.

In the event of a disruption of operation, hydraulic cylinders do not stop the dropping of the carrier unit instantly owing to their construction. Corresponding counterforces have to take effect within the hydraulic cylinder before it can hold the carrier unit and the load weight. The stopping distance of the hydraulic cylinder therein can be up to 100 cm, depending on the scissor lift table and the load weight. However, such a long stopping distance is undesirable for safety braking because sensitive loads may be damaged. It is also conceivable that personal injury might occur in spite of a hydraulic cylinder. Therefore, scissor lift tables known so far do not offer adequate operational safety and pose a source of danger in an ergonomic context. It is therefore the task of the present invention to provide a scissor lift table of the kind laid out in the introduction with a high degree of operational safety.

This task is solved according to the invention by a scissor lift table with the features of claim 1.

According to the invention, a scissor lift table is hereby proposed having a base unit and a carrier unit adjustable relative to the base unit by means of a scissor unit provided with a drive unit. The scissor unit comprises at least one pair of scissor members which have two scissor members being connected to each other by a joint, one of which is mounted with one end on a first pivot bearing arranged stationary on the base unit, and movably guided with the other end on the carrier unit. The other scissor member is mounted with one end on a second pivot bearing arranged stationary on the carrier unit, and movably guided with its other end on the base unit. A safety device of the scissor lift table comprises a monitoring element, which registers parameters of a motor, and a safety element, which processes safety-related signals. The safety device additionally comprises a drive control and a drive brake, wherein the drive control acts on the drive brake in the event of a disruption.

The required operational safety is provided by the interaction according to the invention of specific components. In the case of an abrupt disruption of the proper operation or in the event of the carrier unit dropping, the monitoring element assigned to the drive registers a disruption signal and passes it on to the safety element. The disruption signal is transmitted by means of a wired signal connection. Once the disruption signal has arrived, it is processed by the safety element according to suitable processing schemes. In the instant the safety element recognizes from the processed disruption signal an operational disruption which requires a safety-related intervention, the safety element sends a stop signal to the drive brake. As soon as the stop signal, which is transmitted by a preferably wired signal connection, reaches the drive brake, said brake acts on the drive unit. The drive unit is in a mutual operative connection with the carrier unit so that a dropping carrier unit acts directly on the drive unit. The drive brake thus acts on the drive unit in such a manner that the latter counteracts the dropping carrier unit. In this way it is made sure that the carrier unit remains in its current position and cannot drop any further. The drive brake and the drive unit are sized such that they can brake and hold the carrier unit including the carried load. Due to the interaction of these components, it is possible in the case of an operational disruption to stop the dropping of the carrier unit, to securely hold the carrier unit and to thus provide the desired operational safety.

In a preferred embodiment of the scissor lift table according to the invention, the drive control is realized as a fieldbus control. A fieldbus control establishes a signal connection between the actors of the scissor lift table, such as the drive brake, and sensors of the scissor lift table, such as a motor encoder, and generally requires only little installation effort, which leads to a low investment of material and working hours. Thus, an inexpensive producibility is achieved. Additionally, a fieldbus control offers the option of self-diagnosis. This is particularly advantageous with regard to operational safety because lift tables generally have to comply with a number of safety standards. Furthermore, this type of control has a long lifespan and is reliable. Short signal pathways, which are a characteristic of the fieldbus control, add to its reliability. In the case of a change of components or a supplementation of the scissor lift table by additional components, an adjustment of the fieldbus control to the new configuration of the scissor lift table is required. In this context, too, the fieldbus control is especially suitable since it can be adjusted to the new configuration by qualified personnel with little effort in order to guarantee operational safety. However, any other controls and their adjustment to the system are conceivable, such as real-time Ethernet or other controls from automation technology or cognate fields.

In a preferred embodiment of the scissor lift table according to the invention, the drive control interacts with a PLC control (programmable logic control) and the safety element. A PLC control is an electronic system which has a programmable memory on which control commands and processing schemes for the implementation of desired functions are stored, on the basis of which signals can be processed and the scissor lift table can be controlled. The signaling link of these components leads to a comprehensive processing of all safety-related signals so that all signals are processed centrally. By linking the drive control and the PLC control, it is made possible to command intervening elements for manual activation, such as a key switch and/or an emergency stop switch, via the safety element. This link adds manually securable operational safety to the automatically secured operational safety. It is possible for disruptions to occur during operation which are not or cannot be registered by the monitoring element. Conceivable disruptions include, for example, a person becoming caught in the machinery or another situation endangering personnel. If one of the two switches is activated, it sends a signal to the safety element. The safety element receives the signal via a wired signal connection, processes it, and sends a stop signal to the drive brake, which acts in the afore-described manner on the drive unit and so keeps the carrier unit in its current position.

In a further embodiment of the scissor lift table according to the invention, the drive control acts on the drive brake via an adjusting element in the event of a disruption. The adjusting element generates target values of an output voltage and thereby supplies the drive motor with electricity. The advantage of such a use of the adjusting element lies in the safe actuation of the drive brake. Thus, the drive unit comes to a stop very quickly and safely. It is conceivable to employ a back-feeding adjusting element, preferably in combination with a corresponding energy storage. In this way, the occurring braking energy can be stored and be used when needed. Thus, a four-quadrant operation can be realized, which conserves energy and causes low operational costs.

In a further preferred embodiment of the scissor lift table according to the invention, the adjusting element is a frequency converter. The frequency converter is capable of operating a drive motor of the drive unit. However, it is also conceivable to operate two or more than two drive motors with a corresponding frequency converter. For increasing operational safety, the frequency converter can receive a stop signal of the safety element in the sense of the invention and act on the drive brake in such a manner that it brings the drive to an instantaneous and safe stop.

In another embodiment of the scissor lift table according to the invention, the frequency converter interacts with a lifting element. The lifting element has a sensor function and, by means of a absolute cable value transmitter and/or an absolute length value transmitter, it measures the speed and path during a lifting of the carrier unit and the position when the carrier unit is at rest. It is the advantage in this interaction that, in the event of a disruption, the frequency converter can act on the drive brakes according to the positional information of the carrier unit.

In another preferred embodiment of the scissor lift table according to the invention, the monitoring element is a motor encoder. The motor encoder can monitor the number of revolutions and the direction of rotation of the drive motor and thus contributes to operational safety. Via a signal connection, which is preferably realized as a wired signal connection, the motor encoder constantly sends the number of revolutions and the direction of rotation to the safety element. The safety element compares the signals to a desired operational state and in this way can detect operational disruptions. For example, in a rest position of the carrier unit, there is no number of revolutions of the drive motor. Thus, this value can represent a desired operational state. If the carrier unit drops, the drive motor co-rotates correspondingly due to the operational connection so that a number of revolutions not equal to zero is present. This value is detected by the motor encoder and sent to the safety device. By processing the signal, the safety device recognizes a deviation between the target state and the current state. Thus, a disruption of operation is present, which causes the stop signal to be sent, preferably to the adjusting element or to the frequency converter, respectively.

In a further embodiment of the scissor lift table according to the invention, safety-related queries of operational states are executed on the safety element. This function allows the safety element to correspondingly receive and process signals relating to operational disruptions. The safety-related queries include the determination of the operational state of the fuses for a belt rupture and also for an emergency stop up-position and an emergency stop down-position. It is conceivable to use a hydraulic cylinder so that also the operational state of a fuse of the hydraulic cylinder can be queried for its safety. For querying the operational states, the sensors, fuses and switches are signal-connected to the safety element, preferably via a wired signal connection.

In a further specific embodiment of the scissor lift table according to the invention, the scissor unit is provided with two operationally linked drive units, to each of which a motor encoder is functionally assigned. The drive units serve to actuate the scissor mechanism composed of the two scissor member pairs of a scissor lift table and each comprise a drive motor. The operational connection between the two drive units is preferably formed by a shaft or winding shaft, which is engaging the two drive motors. The motor encoders assigned to the drive units, which are preferably realized as integrated encoders, monitor the number of revolutions and the direction of rotation of the drive motors and thus function as sensors. The motor encoders are signal-connected to the safety device or the safety element, respectively.

In a further specific embodiment of the scissor lift table according to the invention, the safety device comprises a hydraulic cylinder. With a hydraulic cylinder as an additional safety element, the safety device can be designed to be redundant. The addition of a further—independently functioning—safety element to the described arrangement of specific components interacting according to the invention results in an even further increased safety and in a widened option of configuration of scissor lift tables according to the invention for users and customers. For example, it is conceivable that both mentioned safety elements are active and simultaneously provide operational safety. However, it is also possible to only have one of the two safety elements active during operation and to activate the second safety element only in the event of an operational disruption. An active arrangement of specific components interacting according to the invention, which monitor operation, is a conceivable option. If an operational disruption occurs, the arrangement behaves in the afore-described manner in that it holds the carrier unit in its current position. In the instant of the recognized operational disruption, the hydraulic cylinder is activated, which also fixes the carrier unit in its current position. The drive brake can than be released partially or completely. The hydraulic cylinder thus takes over part of the load weight so as to take the load from the drive brake and avoid wear.

Further advantages and advantageous realizations of the subject matter of the invention can be taken from the description, the drawing and the claims.

An exemplary embodiment of a scissor lift table according to the invention is illustrated schematically simplified in the drawing and is to be explained in more detail in the following description.

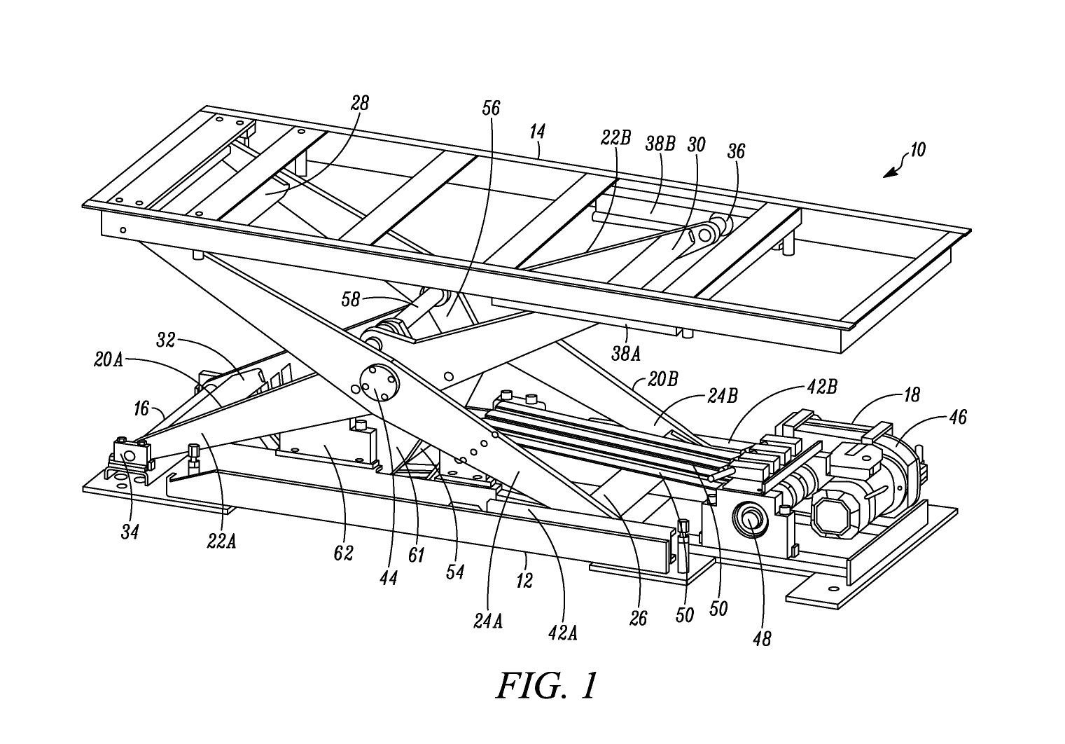

FIG. 1 shows a perspective view of a scissor lift table according to the invention;

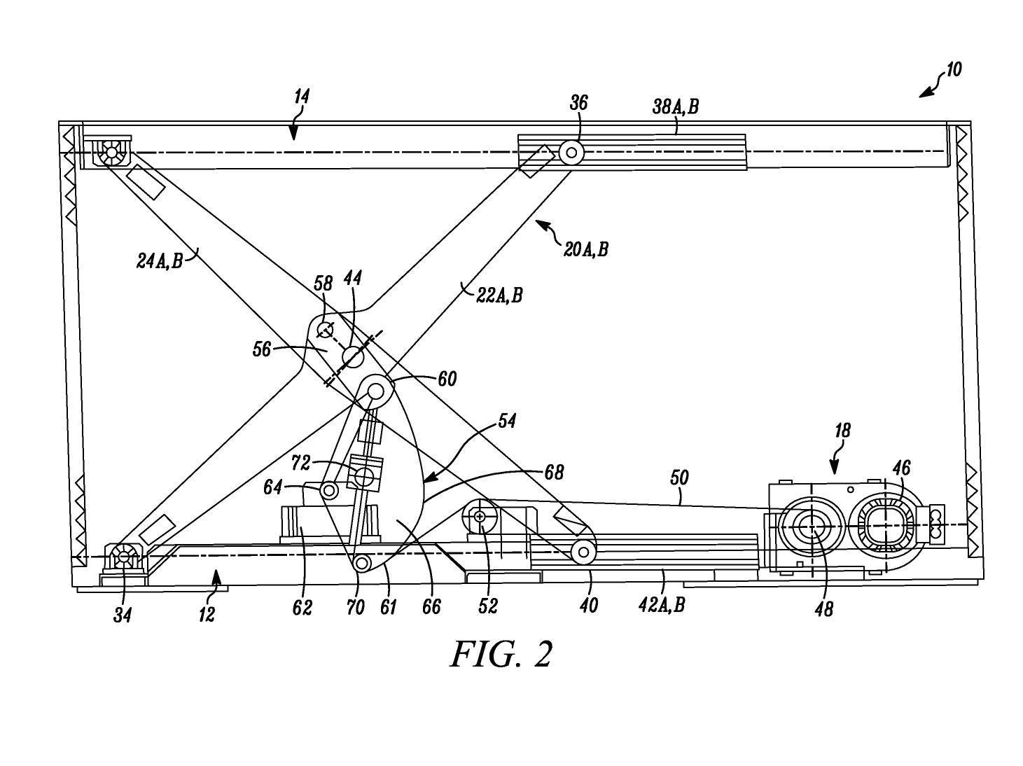

FIG. 2 shows a vertical longitudinal cross section through the scissor lift table; and

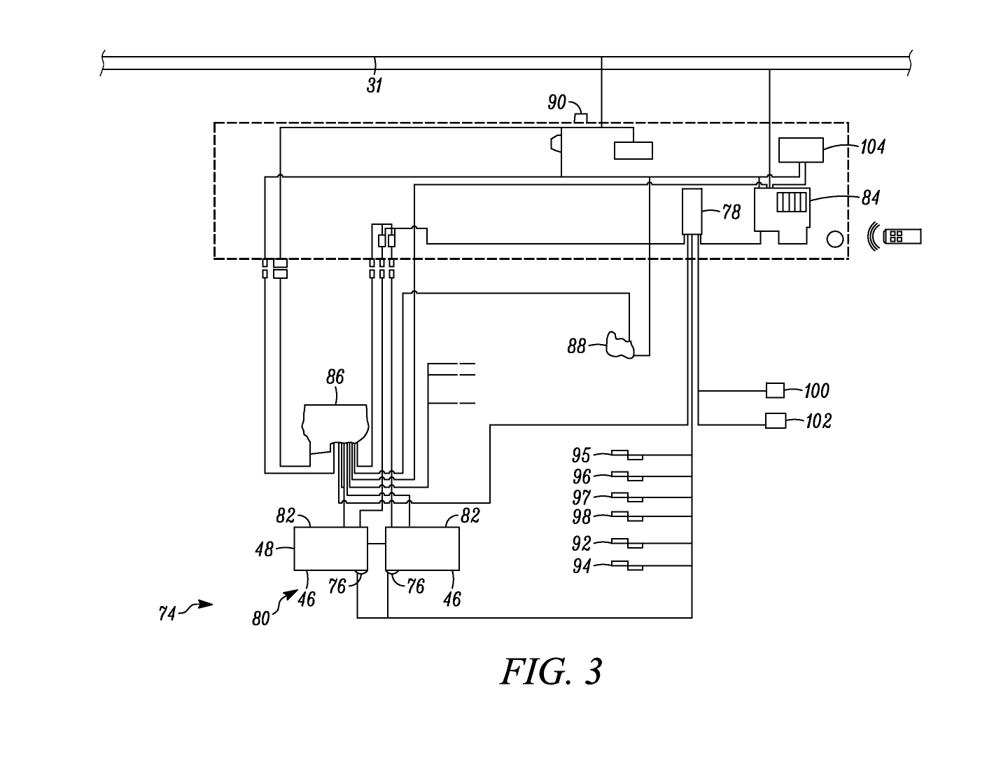

FIG. 3 shows a block diagram of a lift table control and of a safety device.

In the drawing, a scissor lift table 10 is illustrated, which is used, for example, for lifting and lowering immense loads, for example in the field of a production line of an automobile manufacturer, and which can be arranged on a arrangement of rollers not illustrated here or also be mounted stationary.

The scissor lift table 10 comprises a base unit 12 and a carrier unit 14, which is arranged substantially plane-parallel to the base unit 12 and formed in the manner of a table top. The base unit 12 functions as a carrier for a scissor unit 16 and a drive unit 18 of the scissor unit 16.

The scissor unit 16 comprises on both sides in relation to a vertical scissor table length central plane one scissor member pair, 20A respectively 20B, each of which is formed by a first scissor member, 22A respectively 22B, and a second scissor member, 24A respectively 24B, crossing the respective first scissor member. The scissor members 22A and 24A and the scissor members 22B and 24B are connected to each other, respectively, by transverse struts, 26, 28 and 30, 32.

The first scissor members 22A and 22B are each pivotably mounted on one end on a pivot bearing 34, which is formed on the base unit 12. With the end facing away from the pivot bearing 34, the first scissor members 22A and 22B each are movably guided via a roller 36 in a guide rail 38A respectively 38B of the carrier unit 14.

The second scissor members 24A and 24B are each pivotably mounted on one end on a pivot bearing 39, which is arranged on the carrier unit 14 above the pivot bearing 34 of the base unit 12. With the end facing away from the pivot bearing 39, the second scissor members 24A and 24B each are movably guided via a roller 40 in a guide rail 42A and 42B formed on the base unit 12.

Further, the scissor members 22A and 24A and the scissor members 22B and 24B are connected rotatable to each other via a joint 44, respectively.

For the actuation of the scissor mechanism composed of the two scissor member pairs 20A and 20B, the scissor lift table 10 comprises a drive unit 18, which comprises a drive motor 46, which rotationally actuates a winding shaft 48 serving as a winding device. To the winding shaft 48, four drive belts or bands 50 are attached, which are oriented parallel to each other and can be wound from or onto the winding shaft 48 depending on the winding shaft's direction of rotation. The drive belts 50 are guided starting from the winding shaft 48 over a deflection roller 52 formed like a barrel towards a toggle lever arrangement 54.

The toggle lever arrangement 54 has on both sides in relation to the vertical scissor table longitudinal middle plane one first lever element 56, respectively, which is connected via an axis 58 to the associated scissor member 22A and 22B and which is connected on its end facing away from the axis 58 via a joint formed by a joint axis 60 to a second lever element 61, which is pivotably mounted on the base unit 12 via a joint 64 formed on a bearing block 62. The second lever element 61 is formed by two lateral lever shells 66, each of which is pivotably mounted via the joint 64 on the associated bearing block 62, and which are connected to each other by a guiding sheet 68 forming a guiding surface. Depending on the pivot position of the second lever element 61, the drive belts 50, each representing a tensile element, come to lie against the guiding sheet 68.

Furthermore, the drive belts 50 are guided starting from the deflection roller 52 over the guiding sheet 68 and a rod 70, which is formed on the second lever element 61 on the end facing away from the joint axis 60, towards a suspension device 72, which is suspended from the joint axis 60.

The actuation of the afore-described scissor lift table 10 takes place in the manner described in the following.

Starting from a lowered position of the carrier unit 14, the drive motor 46 is actuated in such a manner that the winding shaft 48 is rotated according to FIG. 2 in the clockwise sense. The driving belts 50 are thereby wound onto the winding shaft 48 so that a tensile force is effected on the second lever element 61 of the toggle lever arrangement 54 and the lever element effects an outward motion about the joint 64. This in turn causes an outward pivoting of the scissor members 22A, 22B, 24A and 24B via the first lever element 56 so that the carrier unit 14 is lifted relative to the base unit 12.

For lowering the carrier unit 14, the winding shaft 48 is rotated counter-clockwise so that the drive belts 50 are unwound from the winding shaft 48. Due to the load of the carrier unit 14 and the scissor member pairs 20A and 20B, the second lever element 61 is thus pivoted in, meaning in the direction of the base unit 12, so that the carrier unit 14 is lowered owing to gravity.

In FIG. 3, a block diagram is illustrated, showing an overview of relevant components of a control of the scissor lift table 10 and of corresponding connections. The components are illustrated as object pictograms, largely grouped according to their functionality and their connections illustrated by lines. The lines do not show a concrete connection, such as a cable, but rather an operative connection.

A main switch 90 of the scissor lift table 10 is connected to a local electrical power supply 91 of 3×400 V. The power supply 91 runs through the main switch 90, which allows or interrupts an electrical current flow, and ends at an adjusting element 86 or frequency converter. The frequency converter 86 converts the incoming electric current in such a manner that it complies with the requirements of two drive motors 46. The drive motors 46 are each connected via a power connection to the frequency converter 86. Among each other, the drive motors 46 are connected by the shaft or winding shaft 48 arranged between them, which is illustrated as a thick dotted line. The winding shaft 48 forms an operative connection between the drive motors 46. On each of the drive motors 46, a monitoring device 76 or motor encoder is arranged, which monitors the number of revolutions and the direction of rotation of the associated drive motor 46. Via a signal connection, both motor encoders 76 are connected to a safety element 78. This safety-related connection is illustrated in FIG. 3 by means of a thin dotted line. The safety element 78 comprises at least one fieldbus input card so as to make fieldbus nodes signal-connectable to the safety element 78. Thus, it serves the merging of safety-related signals from connected sensors, fuses and switches. A further safety-related connection is present between the frequency converter 86 and the safety element 78. To the safety element 78, further components of the scissor lift table 10 are connected by means of the safety-related connection. Among them are the two fuses of the emergency stop up-position 92 and the emergency stop down-position 94, which limit a force-actuated lifting motion of the carrier unit 14 upwards and downwards. The fuses 95 to 98 of the four drive belts 50 are also connected via a safety-related connection to the safety element 78. Apart from the automatically functioning fuses, a key switch 100 for manual actuation and an emergency stop 102 are also connected to the safety element 78. The safety element 78 is connected to a PLC control 84, which is optionally operable via IR remote control. To the PLC control 84, a lifting element 88 for querying the lifting is also connected, which measures the speed and path when the carrier unit 14 is lifted and the position when the carrier unit 14 is at rest by means of an absolute cable value transmitter and an absolute length value transmitter. For the measurement, the lifting element 88 is connected to the frequency converter 86. The measured values are displayed on an operating panel 104, which is connected to the lifting element 88 as well as to the PLC control 84. Additionally, the operating panel 104 shows disruption texts, allows a manual operation of the lifting table 10 and visualizes said manual operation.

The case of an operational disruption in a scissor lift table 10 according to the invention, which is monitored with regard to safety by the described arrangement of specific components interacting according to the invention, is explained in more detail as follows.

If an operational disruption occurs during proper operation, it is registered by means of the interaction of sensors, fuses or switches with the safety element 78.

Sensors are constantly measuring an operational state and instantly send the measured values as sensor signals to the safety element 78. These sensors are the two motor encoders 76, which monitor the number of revolutions and the direction of rotation of the drive motor 46. For an operational state measured by a sensor, the safety element 78 compares the currently measured present value to a desired target value. For example, the number of revolutions of the drive motors 46 in a rest position of the carrier unit 14 is 0 rpm. This number of revolutions constitutes a target value for the safety element 78 and serves as a reference. If the carrier unit 14 drops, the safety element 78 determines a corresponding deviation of the present value from the target value and thus recognizes an operational disruption.

Fuses recognize independently if a predefined limit value is exceeded by the change of the operational state. If it is exceeded, the respective fuse sends a corresponding fuse signal to the safety element 78. Fuses are provided for the emergency stop up-position 92 and the emergency stop down-position 94, which limit the force-actuated lifting motion of the carrier unit 14 upwards and downwards. On each of the four drive belts 50, one sensor 95 to 98 is arranged for monitoring a possible belt rupture. The respective fuse sends a corresponding signal to the safety element 78, which therefrom recognizes an operational disruption.

Switches can be actuated manually and provide the user with the ability to indicate an operational disruption. The key switch 100 can be activated by putting in and turning a fitting key. The emergency stop 102 can be activated by pushing a button. The button is safety-related and therefore designed in an optically noticeable manner. When actuated, the switches 100 and 102 send a corresponding switch signal to the safety element 78, which thereby recognizes an operational disruption.

Once the safety element 78 has recognized an operational disruption, it instantly sends a stop signal to the frequency converter 86. The sending of the stop signal is preferably independent of whether the signal is caused or triggered by a sensor signal, a fuse signal or a switch signal. The frequency converter 86 receives the stop signal of the safety element 78 and instantly acts on the drive brake 82 in such a manner that the drive motors 46 come to a sudden and safe stop. Thus, the carrier unit 14 is fixated.

Releasing this fixation is possible preferably by entering an according command or safety feature, such as a digit code, on the operating panel 104. Also, a release by means of a corresponding key on the key switch 100 is conceivable. The autonomous release of the fixation by the lifting table 100 following the resolving of the operational disruption is possible, preferably after an according warning by the scissor lift table, such as an acoustic signal or an optical indication. This warning helps to protect personnel from harm when they are working in the hazard area of the scissor lift table 10 and might be endangered by the release of the fixation, which can result in a factor causing injury.

List of reference signs

| | |
|---|---|
| 10 | Scissor lift table |
| 12 | Base unit |
| 14 | Carrier unit |
| 16 | Scissor unit |
| 18 | Drive unit |
| 20A, 20B | Pair of scissor |
| | members |
| 22A, 22B | Scissor member |
| 24A, 24B | Scissor member |
| 26 | Transverse strut |
| 28 | Transverse strut |
| 30 | Transverse strut |
| 32 | Transverse strut |
| 34 | Pivot bearing |
| 36 | Roller |
| 38A, 38B | Guide rail |
| 39 | Pivot bearing |
| 40 | Roller |
| 42A, 42B | Guide rail |
| 44 | Joint |
| 46 | Drive motor |
| 48 | Winding shaft |
| 50 | Drive belt |
| 52 | Deflection roller |
| 54 | Toggle lever arrangement |
| 56 | First lever element |
| 58 | Axis |
| 60 | Joint axis |
| 61 | Second lever element |
| 62 | Bearing block |
| 64 | Joint |
| 66 | Lever shell |
| 68 | Guiding sheet |
| 70 | Rod |
| 72 | Suspension device |
| 74 | Safety device |
| 76 | Monitoring element |
| 78 | Safety element |
| 80 | Drive control |
| 82 | Drive brake |
| 84 | PLC control |
| 86 | Adjusting element |
| 88 | Lifting element |
| 90 | Main switch |
| 91 | Power supply |
| 92 | Emergency stop up- |
| | position |
| 94 | Emergency stop |
| | down-position |
| 95 | Fuse |
| 96 | Fuse |
| 97 | Fuse |
| 98 | Fuse |
| 100 | Key switch |
| 102 | Emergency stop |
| 104 | Operating panel |

1. A scissor lift table having a base unit and a carrier unit being adjustable relative to the base unit by means of a scissor unit provided with a drive unit, wherein the scissor unit comprises at least one pair of scissor members having two scissor members, which are connected to each other by a joint and one of which is mounted with one end on a first pivot bearing, arranged stationary on the base unit, and movably guided with the other end on the carrier unit, and the other scissor member is mounted with one end on a second pivot bearing, arranged stationary on the carrier unit, and movably guided with its other end on the base unit, and a safety device which comprises a monitoring element and a safety element,
wherein
the safety device additionally comprises a drive control and a drive brake, wherein the drive control actuates the drive brake in the event of a disruption.

2. The scissor lift table according to claim 1,
wherein
the drive control is realized as a fieldbus control.

3. The scissor lift table according to claim 1,
wherein
the drive control interacts with a PLC control and the safety element.

4. The scissor lift table according to claim 1,
wherein
in the event of a disruption, the drive control acts on the drive brake via an adjusting element.

5. The scissor lift table according to claim 4,
wherein
the adjusting element is a frequency converter.

6. The scissor lift table according to claim 5,
wherein
the frequency converter interacts with a lifting element.

7. The scissor lift table according to claim 1,
wherein
the monitoring element is a motor encoder.

8. The scissor lift table according to claim 1,
wherein
on the safety element, safety-related queries of the operation status take place.

9. The scissor lift table according to claim 1,
wherein
the scissor unit is provided with two drive units, which are coupled, preferably via a shaft, and to each of which a monitoring element is assigned.

10. The scissor lift table according to claim 1,
wherein
the safety device comprises a hydraulic cylinder.
